(19) United States
(12) Patent Application Publication
(10) Pub. No.: US 2008/0270419 A1
(43) Pub. Date: Oct. 30, 2008

(54) Portable terminal device and storage medium storing program

(75) Inventor: Akira Watanabe, Hanno-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 12/082,925

(22) Filed: Apr. 14, 2008

(30) Foreign Application Priority Data
Apr. 12, 2007 (JP) 2007-104381

(51) Int. Cl. G06F 17/30

(52) U.S. Cl. 707/10; 707/1; 707/E17.005

(57) ABSTRACT

Provided that use environment conditions (types of access points) fit for using a telephone directory (user use information) are stored and managed in a condition table in association with the telephone directory, a CPU (Central Processing Unit) activates a wireless LAN module at the time of opening the telephone directory, and determines whether a portable terminal device lies within a wireless LAN or a hot spot based on whether wireless communication with an access point present nearby has been established. When the portable terminal device lies within the wireless LAN or the hot spot, the CPU accesses and outputs the telephone directory associated therewith.

### BACKGROUND OF THE INVENTION

1. Field of the Invention

The present invention relates to a portable terminal device that access and outputs user use information usable by a user, and a storage medium storing a program.

2. Description of the Related Art

As disclosed in Unexamined Japanese Patent Application KOKAI Publication No. 2001-86222, for example, there is a technique of classifying and registering telephone directories into a plurality of groups, like business and private, and retrieving a telephone number in a classified group in a case where a cellular phone access and outputs a telephone directory as user use information.

Because the related art requires that a user should designate a group to be searched, however, there may arise a problem such that if a wrong group is designated, a private telephone directory is searched and displayed even when the user is in an office. The same is true of not only a case where the user designates a wrong group, but also a case where the user has forgotten or has lost a cellular phone, which would raise a significant issue on privacy protection. A similar problem would occur in case of information (user use information), such as a dialing history, a ringing history and a schedule book, as well as a telephone directory.

Accordingly, it is an object of the present invention to ensure access to user use information fit for a current use environment in a case of accessing user use information usable by a user.

### SUMMARY OF THE INVENTION

To achieve the object, according to a first aspect of the invention, there is provided a portable terminal device that accesses and outputs user use information usable by a user, comprising:

an environment information storage unit that stores and manages a use environment fit for using each piece of the user use information in association therewith;

an acquisition unit that acquires a current environment; and

an output control unit that accesses and outputs user use information associated by the environment information storage unit with the current environment acquired by the acquisition unit at a time of accessing the user use information.

According to a second aspect of the invention, there is provided a storage medium storing a program that allows a computer to achieve:

an environment information storage function of storing and managing, for each user use information, the user use information and a use environment fit for using the user use information in association with each other;

an acquisition function of acquiring a current environment; and

an output control function of accessing and outputting the user use information associated with the current environment acquired by the acquisition function.

### BRIEF DESCRIPTION OF THE DRAWINGS

FIG. 1 is a block diagram showing a communication network system for cellular phones adapted as portable terminal devices;

FIG. 2 is a block diagram showing fundamental components of the cellular phone;

FIG. 3 is a diagram for explaining telephone directory information which is stored and managed by a management server on the Internet;

FIG. 4 is a diagram for explaining a condition table provided in the cellular phone;

FIG. 5 is a flowchart illustrating the outline of the operation of the feature part (when a telephone directory is opened) of a first embodiment in the general operation of the cellular phone;

FIG. 6 is a diagram for explaining a local telephone number storage section provided in a storage unit in a second embodiment;

FIG. 7 is a diagram for explaining the contents of a condition table in the second embodiment;

FIG. 8 is a flowchart which illustrates the feature part of the second embodiment and whose flow starts when power is given (ON);

FIG. 9 is a diagram for explaining the contents of a condition table in a third embodiment;

FIG. 10 is a flowchart which illustrates the feature part of the third embodiment and whose flow starts when power is given (ON);

FIG. 11 is a flowchart continuous from the one in FIG. 10;

FIG. 12 is a diagram for explaining the contents of a condition table in a fourth embodiment;

FIG. 13 is a diagram for explaining the contents of a ringing history file in the fourth embodiment;

FIG. 14 is a flowchart which illustrates the feature part of the fourth embodiment and whose flow starts when power is given (ON); and

FIG. 15 is a flowchart continuous from the one in FIG. 14.

### DETAILED DESCRIPTION OF THE PREFERRED EMBODIMENTS

### First Embodiment

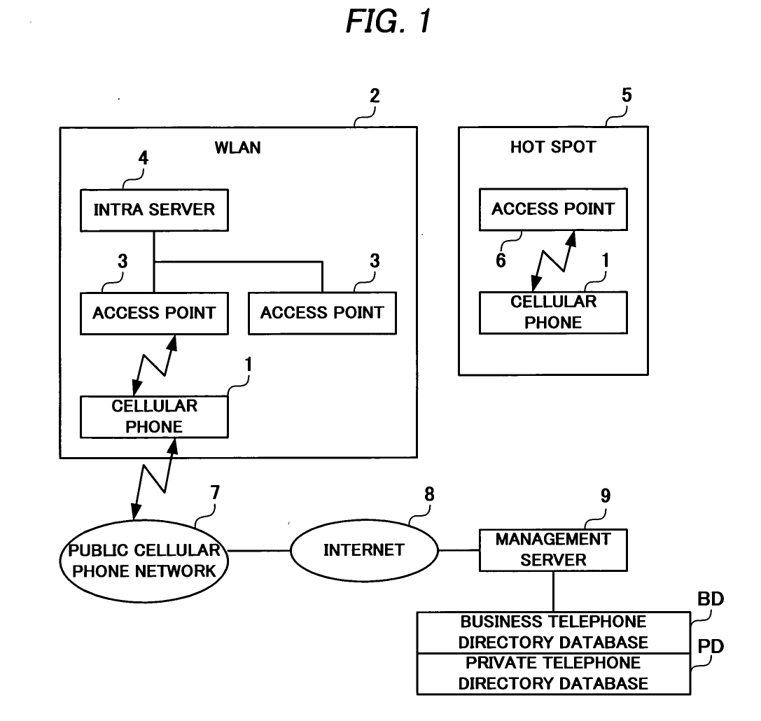

A first embodiment of the present invention will be described below with reference to FIGS. 1 to 5.

FIG. 1 is a block diagram showing a communication network system for cellular phones 1 adapted as portable terminal devices.

The cellular phone 1 has a wireless LAN module installed therein in addition to a communication function, e-mail function, and Internet connecting function (Web access function), and is connectable to a WLAN (Wireless LAN) 2 constructed in a local area (e.g., office or home). In this case, the cellular phone 1 performs fast wireless communication with access points (repeaters) 3 sited in the local area to function as an Internet phone which is compatible with VoIP (Voice over IP) and is usable as an extension when connected to an intra server 4.

The cellular phone 1 can be connected to a hot spot 5 which provides a public Internet service using a wireless LAN in a public facility, such as airport, or a shopping facility as well as an office LAN or a home LAN. The cellular phone 1 performs fast wireless communication with an access point 6 sited in the hot spot 5. The cellular phone 1 is connected to the Internet 8 via a public cellular phone network (mobile communication network) 7. The cellular phone 1 can arbitrarily access a desired Web page from the local area when it is connected to the Internet 8 via a wireless LAN. A management server 9 on the Internet 8 intensively manages user use information (e.g., various telephone directories) for individual users. The management server 9 transmits the telephone directory of a user to a requester according to a transmission request.

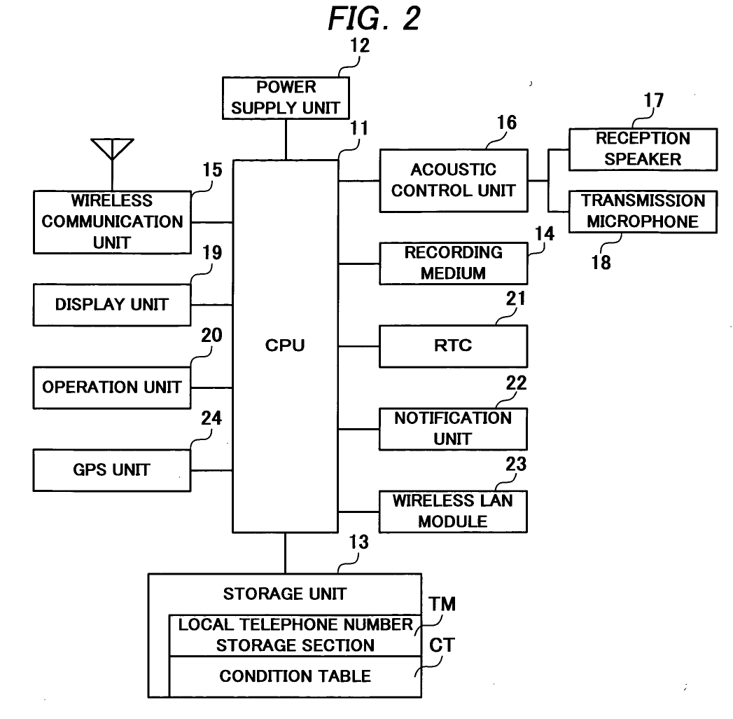

FIG. 2 is a block diagram showing fundamental components of the cellular phone 1.

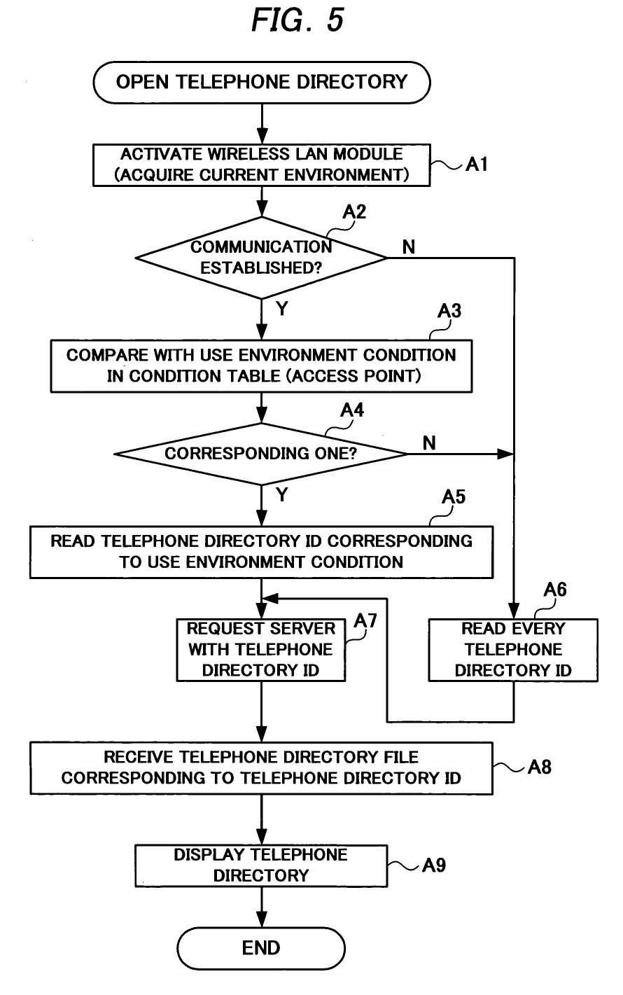

A CPU 11 operates on power supplied from a power supply unit 12 having a secondary battery, and controls the general operation of the cellular phone 1 according to various programs stored in a storage unit 13. The storage unit 13 is configured to have a ROM and RAM. Programs for realizing the first embodiment according to operational procedures illustrated in FIG. 5 to be described later are stored in a program area in the storage unit 13. A local telephone number storage section TM, a condition table CT, etc. which will be described later are provided in a data area in the storage unit 13. A recording medium 14 is a attachable/detachable portable memory and comprises an SD card, an IC card or the like, for example.

A wireless communication unit 15 fetches a signal from the reception side of a transmission/reception section (baseband section) connected to an antenna, and demodulates the signal to a reception baseband signal, which is then audibly output from a reception speaker 17 via an acoustic control unit 16. Then, the wireless communication unit 15 fetches voice data input from a transmission microphone 18 through the acoustic control unit 16, encodes the voice data to a transmission baseband signal, and supplies the transmission baseband signal to the transmission side of the transmission/reception section. The transmission baseband signal is then transmitted from the antenna. Display data received via the wireless communication unit 15 by the e-mail function or the Internet connecting function is supplied to a display unit 19, such as an LCD (Liquid Crystal Display) which can provide high definition display, to be displayed thereon.

An operation unit 20 has various operation keys, a pointing device, etc., and makes a dial input, a character input, a command input and so forth. For example, the operation unit 20 is provided with a TV ON/OFF key, and a record/playback key. The CPU 11 executes a process according to an operation input signal from the operation unit 20. An RTC (Real Time Clock module) 21 constitutes a clock section. The CPU 11 acquires a current date from the RTC 21. A notification unit 22, which has a speaker, an LED (Light Emitting Diode), and a vibrating motor, is driven to notify an incoming call upon telephone ringing or reception of an e-mail and is also driven at the time of giving an alarm.

A wireless LAN module 23 provides a wireless LAN communication function and has an antenna. The wireless LAN module 23 performs fast wireless communication when connected to the WLAN 2 or the hot spot 5. For example, the wireless LAN module 23 in use has a specified use frequency in the 2.4 GHz band a specified communication speed of 11 M bits/sec at a maximum. A GPS (Global Positioning System) unit 24 receives a current position (geographic coordinates) using a satellite and a ground control station. The CPU 11 accesses the GPS unit 24 every one minute, for example, to acquire a GPS measured position and monitor a current user position (position of the cellular phone 1).

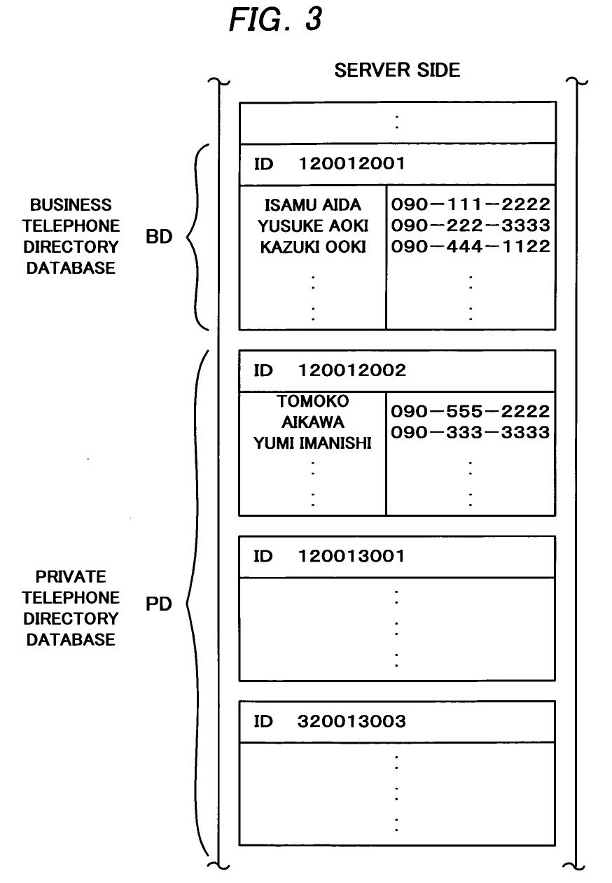

FIG. 3 is a diagram for explaining telephone directory information which is stored and managed by the management server 9 on the Internet 8.

The management server 9 stores and manages plural types of telephone directories for different usages. That is, in the embodiment, the management server 9 stores and manages plural types of telephone directories and the cellular phone 1 acquires a telephone directory from the management server 9 as needed, for example, as a part of a security measure. The management server 9 is provided with a telephone directory database BD which stores and manages business telephone directories user by user and a telephone directory database PD which stores and manages private telephone directories user by user.

In each telephone directory database BD, PD, “telephone directory ID” indicates user identification information and a telephone directory classification. In FIG. 3, a numeral sequence of upper digits “120012” in “120012001”, for example, indicates user identification information, a numeral sequence of lower digits “001” or “0002” indicates a telephone directory classification. In this case, the telephone directory classification “001” indicates a business telephone directory, and the telephone directory classification “002” indicates a private telephone directory. While each telephone directory database BD, PD is structured to store “name” and “telephone number” for each communication counter party, it may store a “mail address”, “fixed telephone number” and the like in addition. Upon reception of a request for transmission of a telephone directory and “telephone directory ID” from the cellular phone 1, the management server 9 reads the telephone directory for the user from that of the telephone directory databases BD and PD which corresponds to the “telephone directory ID”, and transmits the telephone directory to the requesting cellular phone 1.

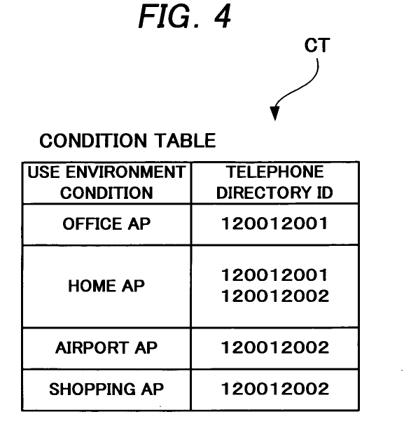

FIG. 4 is a diagram for explaining a condition table CT provided in the cellular phone 1.

The condition table CT stores and manages use environment conditions (types of access points) fit for using telephone directories (user use information) in association with the respective telephone directories, and is structured to associate a “use environment condition” with a “telephone directory ID”. The “use environment condition” indicates the type of the access point 3 in the WLAN 2 or the type of the access point 6 in the hot spot 5. According to the point type, a location, such as “office” or “home”, is set as an environment condition. In FIG. 4, “office AP” indicates an access point in an office, “home AP” indicates an access point in a home, “airport AP” indicates an access point in an airport, “shopping AP” indicates an access point in a shopping facility. If multiple access points are present in an office, their point types are identical.

The “telephone directory ID” is access identification information for designating access to the business telephone directory or private telephone directory. The CPU 11 determines whether or not a user is currently located in the WLAN 2 or the hot spot 5 when it is instructed to open a telephone directory, i.e., determines the type of an access point, and compares the current environment (point type) with a “use environment condition” in the condition table CT. When the current environment corresponds to any “use environment condition”, the CPU 11 reads a “telephone directory (access identification information) ID” associated with the condition, requests the management server 9 of the telephone directory indicated by the “telephone directory ID”, and displays the telephone directory received in response to the request.

In the setting example of the condition table CT, access to the business telephone directory database BD is disabled at a location other than an office and a home in consideration of security at the time the cellular phone 1 is lost or stolen. That is, “120012001” is set as the “telephone directory ID” corresponding to the “office AP”, “120012001” and “120012002” are set as the “telephone directory ID” corresponding to the “home AP”, and “120012002” is set as the “telephone directory ID” for other places, the “airport AP” and “shopping AP”. The business telephone directory can be accessed even at a location other than an office and home on the premise that the user is verified by a password input. The contents of the condition table CT are set arbitrarily by a user operation (the same is true hereinafter).

Next, the operational concept of the cellular phone 1 according to the first embodiment will be explained referring to a flowchart as shown in FIG. 5. The individual functions described in the flowchart are stored in the form of readable program codes and operations according thereto are executed one after another. It is also possible to execute operations according to the program codes, transferred via a transfer medium, one after another. The same is true of other embodiments to be described later. Operations unique to the first embodiment can be executed using a program/data externally supplied via a transfer medium besides a recording medium.

FIG. 5 is the flowchart that illustrates the outline of the operation of the feature part (when a telephone directory is opened) of the first embodiment in the general operation of the cellular phone 1. When the process leaves the flow of FIG. 5, the process returns to the flow (not shown) of the general operation.

First, the CPU 11 acquires a current environment in response to a telephone-directory open instruction given by a user operation or so (step A1). That is, the wireless LAN module 23 is activated to execute wireless communication with an access point present nearly. Next, the CPU 11 determines whether or not the cellular phone 1 lies within the wireless LAN 2 or the hot spot 5 based on whether wireless communication with an access point present nearby has been established (step A2).

When wireless communication with an access point has not been established or when the cellular phone 1 is at a location other than the wireless LAN 2 or the hot spot 5 (step A2; NO), the CPU 11 need not restrict reading of a telephone directory according to the current environment, and therefore reads every “telephone directory ID” (step A6). When wireless communication with any access point has been established or when the cellular phone 1 is in the wireless LAN 2 or the hot spot 5 (step A2; YES), the CPU 11 compares the current environment (point type) with a “use environment condition” in the condition table CT (step A3) to determine whether the current environment corresponds to any “use environment condition (step A4).

When there is no corresponding “use environment condition” (step A4; NO), the CPU 11 need not restrict reading of a telephone directory according to the current environment, and therefore reads every “telephone directory ID” (step A6).

When there is a “use environment condition” corresponding to the current environment (step A4; YES), the CPU 11 reads a “telephone directory ID” corresponding to the “use environment condition” from the condition table CT (step A5).

After reading a “telephone directory ID” according to the current environment, the CPU 11 requests the management server 9 to transmit the telephone directory based on the “telephone directory ID” (step A7). When receiving the “telephone directory ID” along with the request for a telephone directory from the cellular phone 1, the management server 9 reads the telephone directory from a database corresponding to the “telephone directory ID” and transmits the telephone directory to the requesting cellular phone 1. The CPU 11 receives the telephone directory corresponding to the “telephone directory ID” (step A8), and opens and displays a telephone directory screen based on the telephone directory indicated by the “telephone directory ID” (step A9), then terminates the process.

As described above, the cellular phone 1 according to the first embodiment activates the wireless LAN module 23 at the time of opening a telephone directory in a situation where for each telephone directory (user use information), a use environment condition (type of an access point) fit for using the telephone directory is stored and managed in the condition table CT in association with that telephone directory. Then, the cellular phone 1 determines whether or not the cellular phone 1 lies within the wireless LAN 2 or the hot spot 5 as a current environment based on whether wireless communication with an access point present nearby has been established. When the cellular phone 1 is in the wireless LAN 2 or the hot spot 5, the cellular phone 1 accesses and outputs a telephone directory associated therewith.

It is therefore possible to narrow a plurality of telephone directories to one fit for the current environment and access the telephone directory, thus eliminating the need for a user to perform a selection operation and significantly relieving the burden of the user.

The condition table CT stores a “telephone directory ID (access identification information)” for designating access to a business telephone directory or a private telephone directory in association with the “use environment condition”. The cellular phone 1 compares the current environment with the “use environment condition” in the condition table CT. When the current environment corresponds to any “use environment condition”, the cellular phone 1 reads the “telephone directory ID” that corresponds to the “use environment condition”, and requests the management server 9 to transmit the telephone directory.

At the time of acquiring a telephone directory from the management server 9, a telephone directory fit for the current environment can be acquired from a plurality of telephone directories provided for different usages by merely transmitting a “telephone directory ID”.

Although it is determined whether or not the cellular phone 1 is at a specific location, such as an office or home, according to the type of an access point as a “use environment condition” in the first embodiment, whether or not the cellular phone 1 is in a specific facility or area even in an office, for example, may be treated as a “use environment condition”. In this case, an access point in a specific facility or area among a plurality of points in an office has only to be a “use environment condition” (the same is true of following embodiments).

The “use environment condition” is not limited to a location, but may be a time or a day of a week, for example. While a telephone directory is exemplified as user use information in the foregoing description, the user use information may be a schedule book or the like.

### Second Embodiment

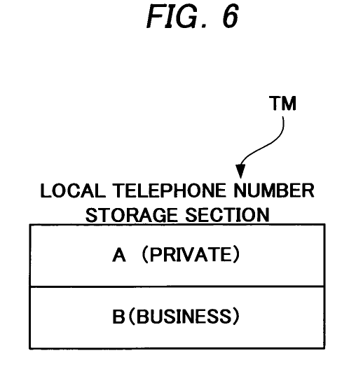

A second embodiment of the present invention will be described below with reference to FIGS. 6 to 8.

In the first embodiment, a telephone directory fit for a current environment is selected from two types of telephone directories and accessed. In the second embodiment, however, a telephone directory according to a local telephone number selected from two types of local telephone numbers which are used separately for a business usage and a private usage may be selectively accessed. In this case, in the second embodiment, an operation of selecting a local telephone number synonymous with an operation of switching a plurality of usages (business usage and private usage) from one to another, so that a telephone directory corresponding to the current environment and the usage currently designated to be selected or the local telephone number currently selected is selected and accessed.

Although the management server 9 stores and manages two types of telephone directories, one for a business usage and the other for a private usage, in the first embodiment, the cellular phone 1 stores and manages two types of telephone directories in the second embodiment. In this case, while two types of telephone directories for different usages are stored in a data area in the storage unit 13 or the internal memory, each telephone directory can be externally supplied from the attachable/detachable recording medium 14.

Same reference numerals are given to those components which are the same basically or in names in both embodiments to avoid the redundant description, and the following description is centralized on the feature part of the second embodiment.

FIG. 6 is a diagram for explaining a local telephone number storage section TM provided in the storage unit 13 in the second embodiment.

The local telephone number storage section TM stores two types of local telephone numbers (local identification information) which are used separately for a business usage and a private usage. For example, a local telephone number “A” is a private telephone number, and a local telephone number “B” is a business telephone number. The CPU 11 alternatively selects either local telephone number from the local telephone number storage section TM as a currently valid number, and performs a dialing process or a ringing process with that telephone number.

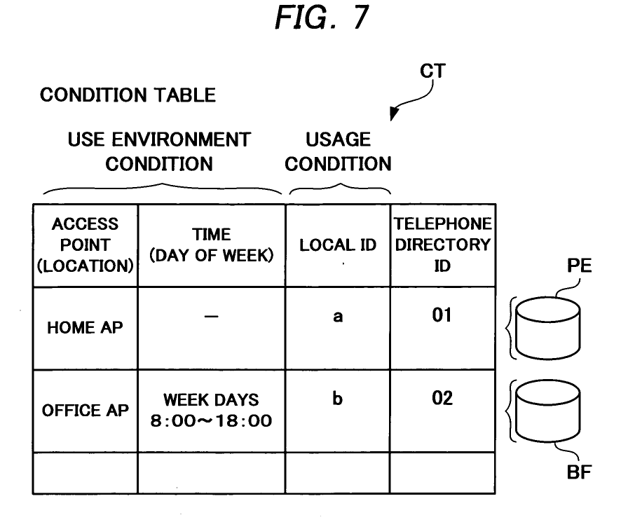

FIG. 7 is a diagram for explaining the contents of a condition table CT in the second embodiment.

The condition table CT in the second embodiment is structured to associate a “use environment condition” with a “usage condition” in addition to a “telephone directory ID”. The “use environment condition” includes an “access point (location)” and “time (including a day of a week)”. Setting condition data to individual items, “access point” and “time” is not restrictive, and condition data may be set to at least one of the items. As in the first embodiment, the “access point” indicates the types of the access points 3 in the WLAN 2 or the type of the access point 6 in the hot spot 5.

“Time” is set as a use environment condition, and in an office, for example, it is set as “8:00 to 18:00 in week days excluding Sunday, Saturday and holidays” as a working time zone. The CPU 11 determines whether the current environment is fit for the use environment condition based on the logical product (AND condition) of the “access point” and the “time”. The “usage condition” indicates a usage (business usage/private usage) which is switched by selecting a local telephone number; in FIG. 7, “a” indicates a local ID designating a business local telephone number and “b” indicates a local ID designating a private local telephone number. When the logical product (AND condition) of the “use environment condition” and the “usage condition” is satisfied, the CPU 11 reads a “telephone directory ID” corresponding to the “use environment condition” and the “usage condition” from the condition table CT. The “telephone directory ID” is information designating a usage-specific telephone directory or a private telephone directory PF or a business telephone directory BF with “01” or “02”.

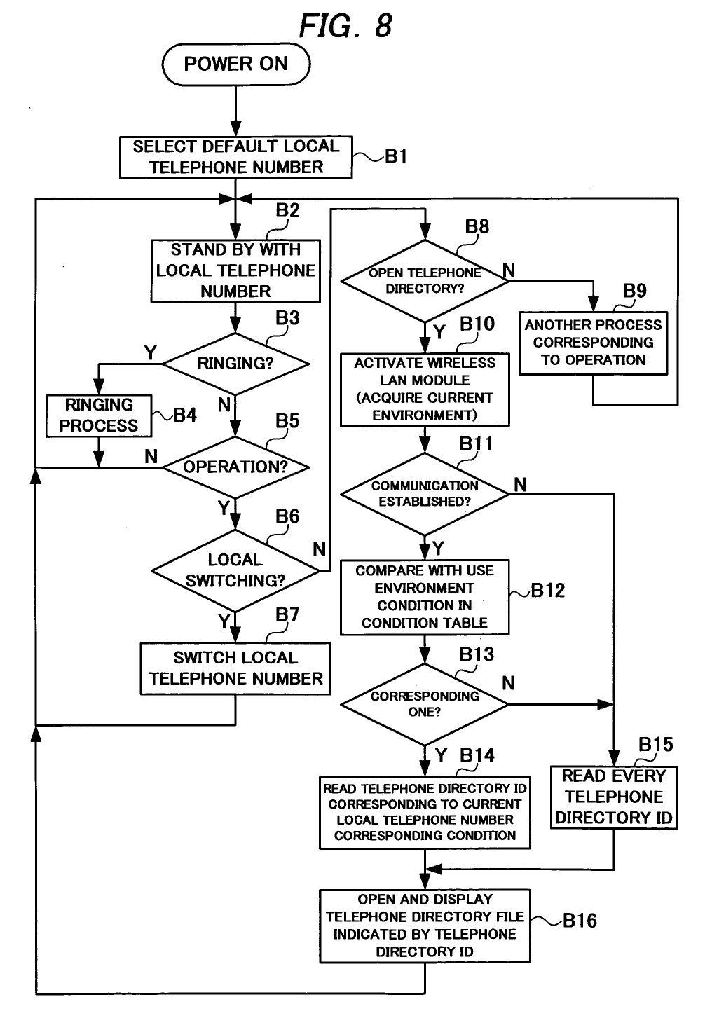

FIG. 8 is a flowchart which illustrates the feature part of the second embodiment and whose flow starts when power is given (ON).

First, the CPU 11 selects a local telephone number (e.g., a private local telephone number) which is determined as a default number as a currently valid number (step B1), and enters a standby state for phone ringing with the local telephone number (step B2).

Next, the CPU 11 determines whether phone ringing has been detected (step B3).

When it is determined that phone ringing has been detected (step B3; YES), the CPU 11 executes a ringing process (step B4), then returns to step B2.

When it is determined that phone ringing has not been detected (step B3; NO), the CPU 11 determines whether some kind of operation has been executed (step B5).

When it is determined that some kind of operation has not been executed (step B5; NO), the CPU 11 returns to step B2.

When it is determined that some kind of operation has been executed (step B5; YES), the CPU 11 determines whether an operation of switching the local telephone number (usage switching operation) has been executed (step B6).

When it is determined that the operation of switching the local telephone number has been executed (step B6; YES), the CPU 11 switches the currently valid local telephone number to a new local telephone number (step B7), then returns to step B2 to stand by for phone ringing with the new local telephone number.

When it is determined that the operation of switching the local telephone number has not been executed (step B6; NO), the CPU 11 determines whether an operation of instructing opening of a telephone directory has been executed (step B8).

When it is determined that the operation of instructing opening of a telephone directory has not been executed (step B8; NO), the CPU 11 executes a dialing process, a mail creating process, a process of setting the condition table CT, or the like as a process corresponding to that operation (step B9), then returns to step B2.

When it is determined that the operation of instructing opening of a telephone directory has been executed (step B8; YES), the CPU 11 acquires the current environment (step B10). That is, the CPU 11 activates the wireless LAN module 23 to carry out wireless communication with an access point present nearby. Then, the CPU 11 determines whether or not the cellular phone 1 is in the WLAN 2 or the hot spot 5 based on whether wireless communication with an access point has been established (step B11).

When wireless communication with an access point has not been established or when the cellular phone 1 is currently present at a location other than the WLAN 2 or the hot spot 5 (step B11; NO), the CPU 11 need not restrict reading of a telephone directory according to the current environment, and therefore reads every “telephone directory ID” (step B15).

When wireless communication with any access point has been established or when the cellular phone 1 is currently present in the WLAN 2 or the hot spot 5 (step B11; YES), the CPU 11 compares the current environment with a “use environment condition” in the condition table CT (step B12).

That is, when the comparison of the current environment (type of an access point) with the “access point” in the “use environment condition” results in that the current environment corresponds to any “use environment condition”, the CPU 11 further compares the current date (current environment) acquired by the RTC 21 with the “time” in the “use environment condition”.

Then, the CPU 11 determines whether the current date corresponds to the “time” (step B13). In this case, when condition data is set to one of the individual items “access point” and “time” and condition data is not set to the other item, the contents of the condition-data set item is compared with the current environment.

When it is determined that the current environment corresponds to no “use environment condition” (step B13; NO), the CPU 11 reads every “telephone directory ID” (step B15), then proceeds to step B16.

When it is determined that the current environment corresponds to any “use environment condition” (step B13; YES), the CPU 11 reads a “telephone directory ID” corresponding to a “local ID”, which corresponds to the “use environment condition” and designates a currently valid local telephone number, from the condition table CT (step B14), opens and displays a telephone directory screen based on a telephone directory indicated by the “telephone directory ID” (step B16), then returns to step B2.

As described above, the condition table CT in the second embodiment is structured to associate a “use environment condition” with a “usage condition” which indicates a business usage or a private usage in addition to a “telephone directory ID”. When the use environment corresponds to the current environment and corresponds to the currently selected usage, the CPU 11 reads a “telephone directory ID” associated with the environment and usage, and displays a telephone directory corresponding to the “telephone directory ID”.

This makes it possible to read a telephone directory which is fit for the current environment and usage from plural types of telephone directories.

In this case, the usage can be switched (between a business usage and a private usage) by the operation of selecting a desired local telephone number from a plurality of local telephone numbers. Because each usage-specific telephone directory is stored in the storage unit 13 or the recording medium 14, quick access to the telephone directory is possible.

Although the usage is switched by the operation of selecting a local telephone number in the second embodiment, such switching is not restrictive. For example, a plurality of usage modes can be arbitrarily switched from one mode to another by a user's operation.

Although a business usage and a private usage are exemplified in the second embodiment, usages are optional and may be a family usage, a hobby usage, a male usage, and so forth.

### Third Embodiment

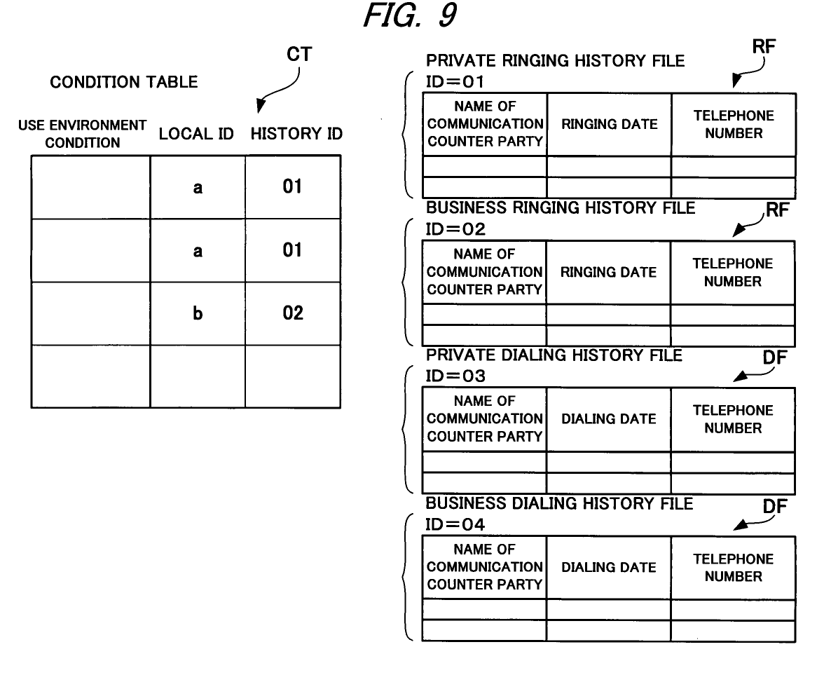

A third embodiment of the present invention will be described below with reference to FIGS. 9 to 11.

In the first and second embodiments, a telephone directory is exemplified as user use information, whereas in the third embodiment, a communication history is used as user use information. In the third embodiment, two types of local telephone numbers which are used separately for a business usage and a private usage are alternatively selected according to the current environment.

Same reference numerals are given to those components which are the same basically or in names in the first and third embodiments to avoid the redundant description, and the following description is centralized on the feature part of the third embodiment.

FIG. 9 is a diagram for explaining the contents of a condition table CT in the third embodiment.

The condition table CT in the third embodiment is structured to associate a “use environment condition”, “local ID” and “history ID” with one another. The “use environment condition” indicates the aforementioned “access point (location)”, and may include a “time (including a day of a week)” in addition to an “access point (location)” as per the second embodiment. The “local ID” designates a plurality of local telephone numbers (local identification information) which are used separately according to the usage at the time of executing a communication process. In FIG. 9, for example, “a” indicates a local ID designating a private local telephone number and “b” indicates a local ID designating a business local telephone number.

The “history ID” is history identification information to identify a ringing history file RF or a dialing history file DF according to a private usage or a business usage. In FIG. 9, for example, “01” in the “history ID” is information to identify a ringing history file RF for a private usage and “02” is information to a ringing history file RF for a business usage. The ringing history file RF is structured to have items, such as “ringing date”, “name of communication counter party” and “telephone number” thereof. The same is applied to the dialing history file DF to which a “history ID” designating a dialing history file DF for a private usage and a “history ID” designating a dialing history file DF for a business usage are assigned. For example, “03” in the “history ID” is information to identify a dialing history file DF for a private usage, and “02” is information to identify a dialing history file DF for a business usage.

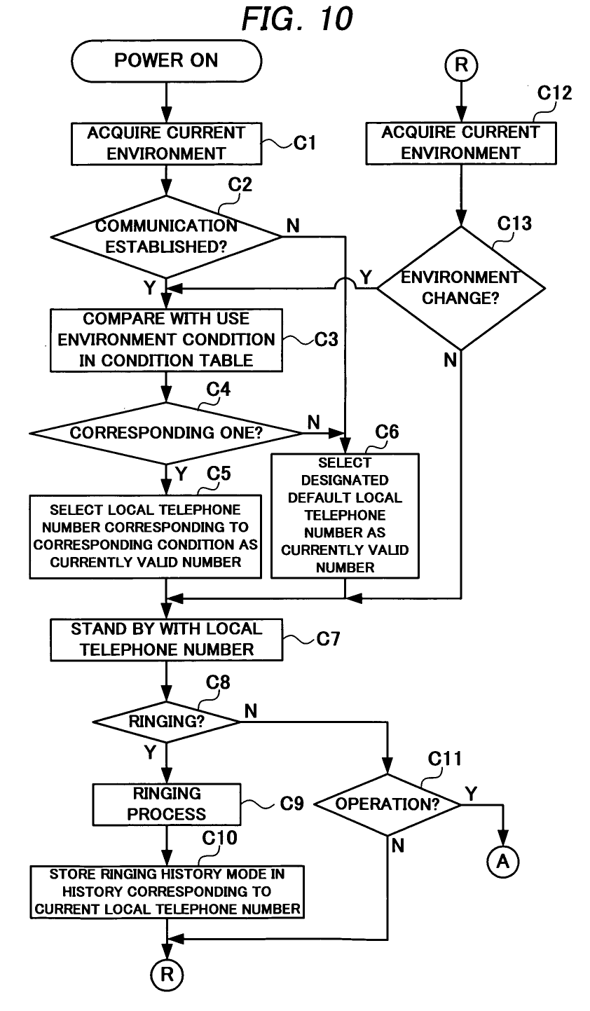

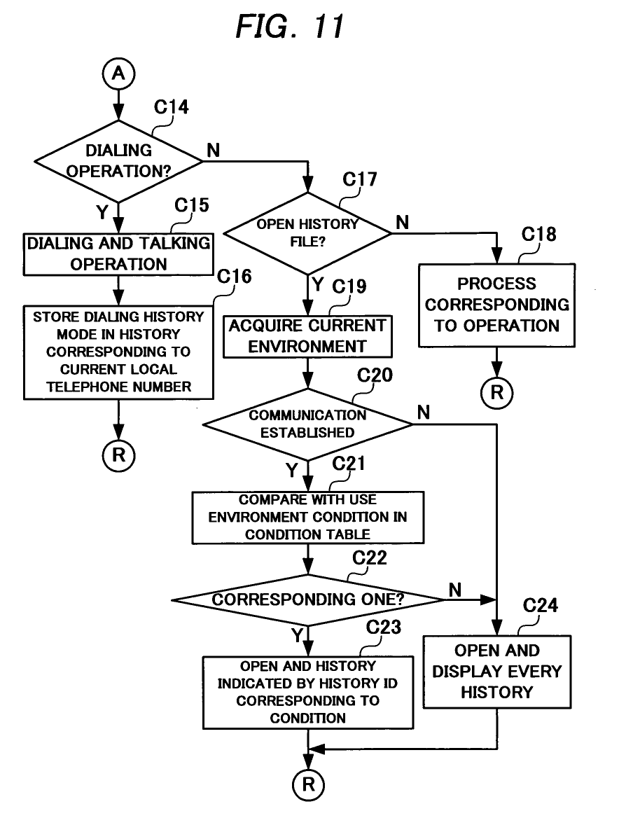

FIGS. 10 and 11 present a flowchart which illustrates the feature part of the third embodiment and whose flow starts when power is given (ON).

In response to the power-ON operation, the CPU 11 acquires the current environment (step C1). That is, the CPU 11 activates the wireless LAN module 23 to carry out wireless communication with an access point present nearby. Then, the CPU 11 determines whether or not the cellular phone 1 is in the WLAN 2 or the hot spot 5 based on whether wireless communication with an access point has been established (step C2).

When wireless communication with an access point has not been established or when the cellular phone 1 is currently present at a location other than the WLAN 2 or the hot spot 5 (step C2; NO), the CPU 11 selects a local telephone number determined as a default number as a currently valid number (step C6), and then proceeds to step C7.

When wireless communication with any access point has been established or when the cellular phone 1 is currently present in the WLAN 2 or the hot spot 5 (step C2; YES), the CPU 11 compares the current environment (point type) with a “use environment condition” in the condition table CT (step C3), and determines whether the current environment corresponds to any “use environment condition” (step C4).

When there is no corresponding “use environment condition” (step C4; NO), the CPU 11 selects a local telephone number determined as a default number (e.g., a private local telephone number) as a currently valid number (step C6), and then proceeds to step C7.

When there is a corresponding “use environment condition” (step C4; YES), the CPU 11 selects a local telephone number indicated by the “local ID” corresponding to the “use environment condition” from the condition table CT (step C5), and then proceeds to step C7.

After selecting the currently valid local telephone number this way, the CPU 11 stands by for phone ringing with the local telephone number (step C7), and determines whether phone ringing has been detected (step C8).

When it is determined that phone ringing has been detected in the standby state (step C8; YES), the CPU 11 executes a ringing process (step C9). Then, the CPU 11 generates a ringing history record from the contents of the current ringing, reads a “history ID” corresponding to from the condition table CT based on the “use environment condition” corresponding to the “local ID” which designates the current “local telephone number”, and additionally stores the ringing history record in the ringing history file RF indicated by the “history ID” (step C10).

Then, the CPU 11 activates the wireless LAN module 23 to acquire the current environment (step C12), and compares the previously acquired environment with the current environment to determine whether there is an environmental change (step C13).

When it is determined that there is no environmental change (step C13; NO), the CPU 11 proceeds to step C7 to stand by.

When it is determined that there is an environmental change (step C13; YES), the CPU 11 proceeds to step C3 to compare the currently acquired environment with a “use environment condition” in the condition table CT, and selects a “local telephone number” according to whether the currently acquired environment corresponds to any “use environment condition” (steps C4 to C5).

When it is determined in this standby state that phone ringing has not been detected (step C8; NO), the CPU 11 determines whether any operation has been executed (step C11).

When it is determined that operation has been executed (step C11; YES), the CPU 11 goes to the flow illustrated in FIG. 11 and determines whether the executed operation is a phone dialing operation (step C14).

When it is determined that the executed operation is a phone dialing operation (step C14; YES), the CPU 11 executes a dialing and talking operation (step C15). Then, the CPU 11 generates a dialing history record from the contents of the current dialing, then reads a corresponding “history ID” from the condition table CT based on the “use environment condition” corresponding to the “local ID” which designates the current “telephone directory ID”, additionally stores the dialing history record in the dialing history file DF indicated by the “history ID” (step C16), and proceeds to step C12 in the flow illustrated in FIG. 10. When it is determined that any operation has not been executed (step C11; No), the control progresses to step C12.

When it is determined that the executed operation is not a phone dialing operation (step C14; NO), the CPU 11 determines whether an operation of instructing opening of a communication history has been executed (step C17).

When it is determined that the operation of instructing opening of a communication history has not been executed (step C17; NO), the CPU 11 executes, for example, a mail creating process, a process of setting the condition table CT, or the like as a process corresponding to that operation (step C18), then proceeds to step C12.

When it is determined that the operation of instructing opening of a communication history has been executed (step C17; YES), the CPU 11 activates the wireless LAN module 23 to acquire the current environment (step C19), and determines whether or not the cellular phone 1 is in the WLAN 2 or the hot spot 5 based on whether wireless communication with an access point has been established (step C20).

When it is determined that the cellular phone 1 is present at a location other than the WLAN 2 or the hot spot 5 (step C20; NO), the CPU 11 accesses all the ringing history files RF and dialing history files DF and open and display the files RF and DF (step C24), then proceeds to step C12 in the flow illustrated in FIG. 10.

When it is determined that the cellular phone 1 is present in the WLAN 2 or the hot spot 5 (step C20; YES), the CPU 11 compares the current environment with a “use environment condition” in the condition table CT (step C21), and determines whether the current environment corresponds to any “use environment condition” (step C22).

When it is determined that the current environment corresponds to no “use environment condition” (step C22; NO), the CPU 11 opens and displays all history files (step C24), then proceeds to step C12 in the flow illustrated in FIG. 10.

When there is a corresponding “use environment condition” (step C22; YES), the CPU 11 reads a “history ID” corresponding to the “use environment condition” from the condition table CT, accesses a history file indicated by the “history ID” and opens and displays the history file (step C23), then proceeds to step C12 in the flow illustrated in FIG. 10.

As described above, in a state where a plurality of local telephone numbers (local identification information) which are used separately according to the usage at the time of executing a communication process in the third embodiment, when having executed the communication process based on any selected local telephone number, the CPU 11 stores and manages the communication history corresponding to the local telephone number as user use information.

This can ensure management of communication histories usage by usage. In addition, a history file which is fit for the current environment can be selected from a plurality of usage-specific communication histories (business and private ringing history files RF, and business and private dialing history files DF). In the third embodiment, one of a plurality of local telephone numbers can be selected according to the current environment without executing an operation of switching the local telephone number.

Although a business usage and a private usage are exemplified in the third embodiment, usages are optional and may be a family usage, a hobby usage, a male usage, and so forth.

While business and private ringing history files RF, and business and private dialing history files DF are stored and managed by the cellular phone 1 in the third embodiment, individual pieces of history data may be intensively managed by the management server 9.

### Fourth Embodiment

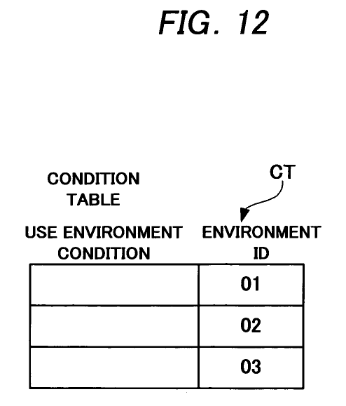

A fourth embodiment of the present invention will be described below with reference to FIGS. 12 to 15.

In the third embodiment, a “use environment condition” is associated with a ringing history file RF and a dialing history file DF. In the fourth embodiment, however, every time user use information is processed, an “environment ID” indicating the current environment is added to the user use information. That is, at the time of generating a communication history record (ringing/dialing history record), an “environment ID” is added to the communication history record. Note that user use information is not limited to a communication history, but may be a file other the communication history (e.g., image file, sound file, telephone directory file, schedule book, or memo file), and at the time of creating a new file or accessing an existing file, an “environment ID” is added to the file.

Same reference numerals are given to those components which are the same basically or in names in the first and fourth embodiments to avoid the redundant description, and the following description is centralized on the feature part of the fourth embodiment.

FIG. 12 is a diagram for explaining the contents of a condition table CT in the fourth embodiment.

The condition table CT is structured to store an “environment ID” in association with plural types of “use environment conditions”. As mentioned above, the “use environment condition” indicates the type of the access point 3 in the WLAN 2 or the type of the access point 6 in the hot spot 5, and the “environment ID” indicates a location, such as “office” or “home”.

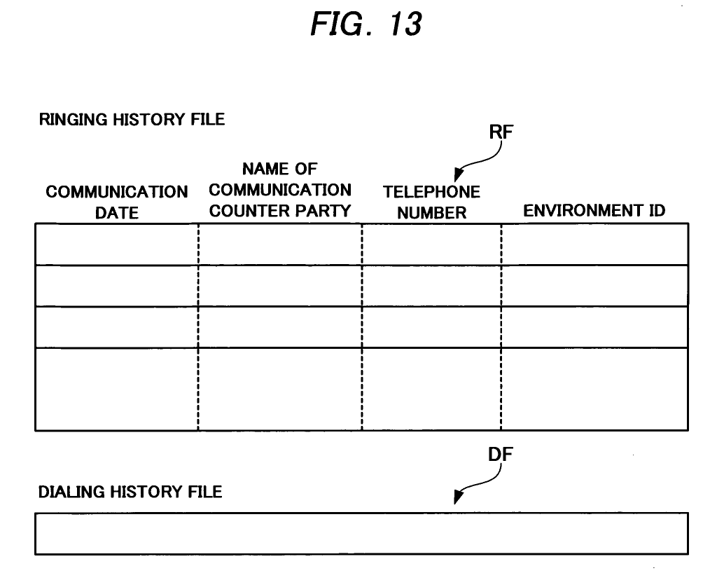

FIG. 13 is a diagram for explaining the contents of a ringing history file RF in the fourth embodiment.

The ringing history file RF is structured to store a “communication date”, “name of communication counter party” and “telephone number” for each communication counter party (each history record), and store an “environment ID” indicating the current environment at the time of phone ringing. Every time a communication history record is generated, the CPU 11 adds an “environment ID” indicating the current environment to the communication history record. At the time of reading the contents of the ringing history file RF (at the time of opening the history file), the CPU 11 extracts a history record corresponding to the current environment from the ringing history file RF and displays the history record. The dialing history file DF has a similar structure.

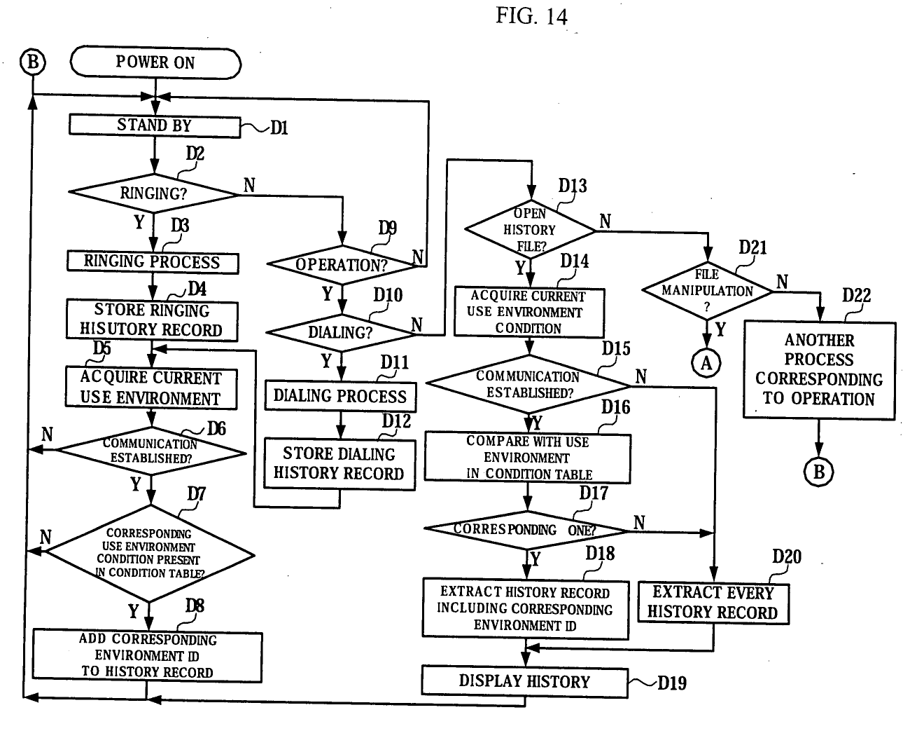

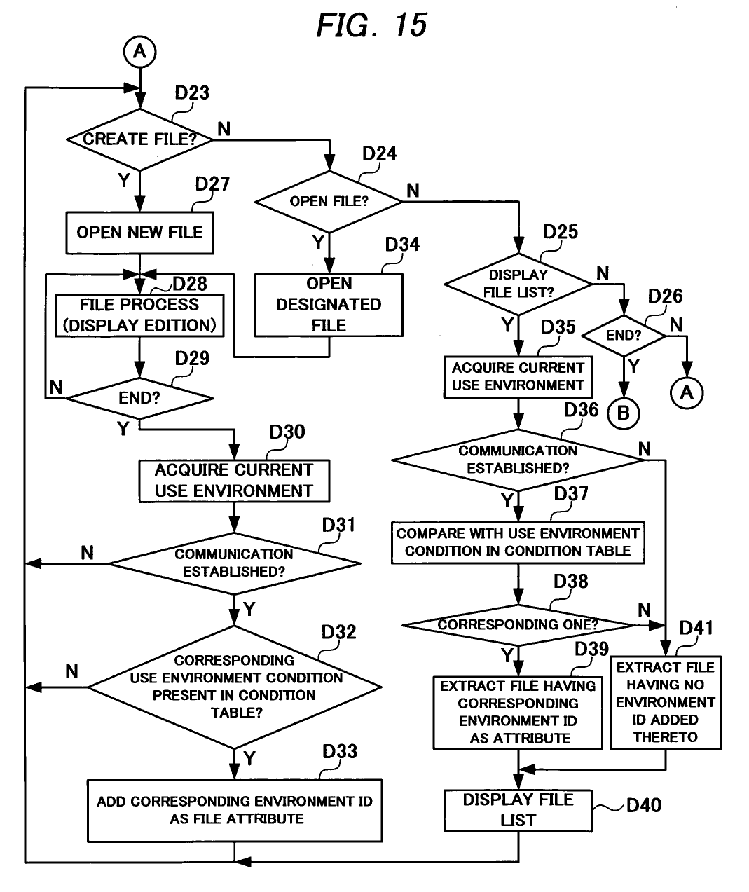

FIGS. 14 and 15 present a flowchart which illustrates the feature part of the fourth embodiment and whose flow starts when power is given (ON).

When power is given, the CPU 11 first becomes a standby state for ringing (step D1), and determines whether phone ringing has been detected (step D2).

When it is determined that phone ringing has been detected (step D2; YES), the CPU 11 executes a ringing and talking process (step D3), generates a ringing history record from the contents of the current ringing, additionally stores the ringing history record (step D4), and activates the wireless LAN module 23 to acquire the current environment (step D5). Then, the CPU 11 determines whether or not the cellular phone 1 is in the WLAN 2 or the hot spot 5 based on whether wireless communication with an access point has been established (step D6).

When wireless communication with an access point has not been established or when the cellular phone 1 is currently present at a location other than the WLAN 2 or the hot spot 5 (step D6; NO), the CPU 11 returns to step D1 to go back to a standby state.

When the cellular phone 1 is currently present in the WLAN 2 or the hot spot 5 (step D6; YES), the CPU 11 further searches the condition table CT to determine whether there is a “use environment condition” corresponding to the current environment based on the current environment (step D7).

When there is no corresponding “use environment condition” (step D7; NO), the CPU 11 returns to step D1 to go back to a standby state.

When a “use environment condition” corresponding to the current environment is set in the condition table CT (step D7; YES), the CPU 11 reads an “environment ID” corresponding to the “use environment condition” and adds the “environment ID” to the current ringing history record (step D8), then returns to step D1 to go back to a standby state.

When it is determined that phone ringing has not been detected (step D2; NO), the CPU 11 determines whether any operation has been executed (step D9).

When no operation has been executed in the ringing standby state (step D9; NO), the CPU 11 proceeds to step D1.

When it is determined that some kind of operation has been executed in the ringing standby state (step D9; YES), the CPU 11 determines whether the executed operation is a phone dialing operation (step C14).

When it is determined that the executed operation is a phone dialing operation (step D10; YES), the CPU 11 executes a dialing and talking operation (step D11). Then, the CPU 11 generates a dialing history record from the contents of the current dialing, then additionally stores the dialing history record in the dialing history file DF (step D12), and proceeds to step D5.

When it is determined that the executed operation is not a phone dialing operation (step D10; NO), the CPU 11 determines whether the executed operation is an operation of instructing opening of a communication history (step D13).

When it is determined that the executed operation is not the operation of instructing opening of a communication history (step D13; NO), the CPU 11 determines whether the executed operation is a file manipulation (step D21).

When it is determined that a file manipulation has been executed (step D21; YES), the CPU 11 proceeds to step D23 in the flow illustrated in FIG. 15.

When it is determined that the file manipulation has not been executed (step D21; NO), the CPU 11 executes, for example, a mail creating process, a process of setting the condition table CT, or the like as a process corresponding to that operation (step D22), then returns to step D1. Hereinafter, as in the case of ringing, the CPU 11 acquires the current environment, and when a “use environment condition” corresponding to the current environment is set, the CPU 11 reads an “environment ID” corresponding to the “use environment condition” from the condition table CT, and adds the “environment ID” to the current ringing history record (steps D5 to D8).

When the operation of instructing opening of a communication history has been executed (step D13; YES), the CPU 11 activates the wireless LAN module 23 to acquire the current environment (step D14), and determines or not whether the cellular phone 1 is in the WLAN 2 or the hot spot 5 based on whether wireless communication with an access point has been established (step D15).

When it is determined that the cellular phone 1 is present at a location other than the WLAN 2 or the hot spot 5 (step D15; NO), the CPU 11 accesses all the ringing history files RF and dialing history files DF and open and display the files RF and DF (step D20), then proceeds to step D19.

When it is determined that the cellular phone 1 is present in the WLAN 2 or the hot spot 5 (step D15; YES), the CPU 11 compares the current environment with a “use environment condition” in the condition table CT (step D16), and determines whether the current environment corresponds to any “use environment condition” (step D17).

When it is determined that the current environment corresponds to no “use environment condition” (step D17; NO), the CPU 11 proceeds to the step D20 to open and display all history files.

When there is a corresponding “use environment condition” (step D17; YES), the CPU 11 reads a “history ID” corresponding to the “use environment condition” from the condition table CT, retrieves an arbitrary selected ringing history file RF or dialing history file DF as a target to be opened based on the “history ID” at the time of instructing opening of a history file, extracts individual history records including the “history ID” (step D18), displays the extracted records (step D19), and then returns to step D1.

When the file manipulation has been executed (step D21; YES), the CPU 11 goes to the flow of FIG. 15 to determine whether a file creation is instructed (step D23).

When it is determined that a file creation is not instructed (step D23; NO), the CPU 11 determines whether file opening is instructed (step D24).

When it is determined that file opening has not been instructed (step D24; NO), the CPU 11 determines whether display of a file list is instructed (step D25).

When it is determined that display of a file list is not instructed (step D25; NO), the CPU 11 determines whether the end of file is instructed (step D26). When the end of file is instructed (step D26; YES), the CPU 11 returns to step D1 in FIG. 14 to go back to a standby state.

When the end of file is not instructed (step D26; NO), the CPU 11 returns to step D23.

When it is determined in the step D23 that a file creation is instructed (step D23; YES), the CPU 11 opens and displays a new file (step D27), starts executing a file creating process (data edition/display process) (step D28), and executes the file creating process until the file creation is terminated.

When termination of the file creation is instructed (step D29; YES), the CPU 11 activates the wireless LAN module 23 to acquire the current environment (step D30), and determines whether or not the cellular phone 1 is in the WLAN 2 or the hot spot 5 based on whether wireless communication with an access point has been established (step D31).

When it is determined that the cellular phone 1 is present at a location other than the WLAN 2 or the hot spot 5 (step D31; NO), the CPU 11 returns to step D23.

When the cellular phone 1 is present in the WLAN 2 or the hot spot 5 (step D31; YES), the CPU 11 searches the condition table CT based on the current environment, and determines whether there is a “use environment condition” corresponding to the current environment (step D32).

When there is no corresponding use environment condition (step D32; NO), the CPU 11 returns to step D23.

When a “use environment condition” corresponding to the current environment is set in the condition table CT (step D32; YES), the CPU 11 reads an “environment ID” corresponding to the “use environment condition”, adds the “use environment condition” to the currently generated file as its file attribute (step D33), and returns to step D23.

When opening of a file is instructed in the step D24 (step D24; YES), the CPU 11 designates the file, and opens and displays the file (step D34). Then, as in the file creation, the CPU 11 acquires the current environment when termination of the file creation is instructed during execution of the file creating process (data edition/display process). If the “use environment condition” corresponding to the current environment is set in the condition table CT, the CPU 11 reads an “environment ID” corresponding to the “use environment condition”, and adds the “use environment condition” to the currently designated file as its file attribute (steps D28 to D33). When display of a file list is instructed (step D25; YES), the CPU 11 activates the wireless LAN module 23 to acquire the current environment (step D35), and determines whether or not the cellular phone 1 is in the WLAN 2 or the hot spot 5 based on whether wireless communication with an access point has been established (step D36).

When the cellular phone 1 is present at a location other than the WLAN 2 or the hot spot 5 (step D36; NO), the CPU 11 extracts files having no “environment ID” added thereto as a file attribute from various files (Step D41), displays a list of the files (step D40), and returns to step D23.

When the cellular phone 1 is present in the WLAN 2 or the hot spot 5 (step D36; YES), the CPU 11 compares the current environment with a “use environment condition” in the condition table CT (step D37), and determines whether the current environment corresponds to any “use environment condition” (step D38). When the current environment does not correspond to any “use environment condition” (step D38; NO), the CPU 11 extracts a file having no “environment ID” (step D41), and proceeds to step D40.

When there is a corresponding “use environment condition” (step D38; YES), the CPU 11 reads an “environment ID” corresponding to the “use environment condition” from the condition table CT, and at the same time extracts files having the “environment ID” added thereto as a file attribute from various files based on the “environment ID” (step D39). Then, the CPU 11 displays a list of the extracted files (step D40), and then returns the process to step D23.

According to the fourth embodiment, as described above, at the time of generating a communication history record, the CPU 11 adds an “environment ID” to the communication history record, extracts a history record corresponding to the current environment from the history file at the time of opening the history file and displays the history record, thus making it possible to read records fit for the current environment.

In this case, a communication history is not restrictive, and an “environment ID” may be added to other files (such as image file, sound file, telephone directory file, schedule book, and memo file), and a file corresponding to the current environment is extracted from various files and is displayed at the time of displaying a file list. This can ensure reading of a file fit for the current environment.

In each of the above-described embodiments, the wireless LAN module 23 is activated to execute wireless communication with an access point located nearby, and it is determined whether or not the cellular phone 1 is in the WLAN 2 or the hot spot 5 as the current environment based on whether wireless communication with an access point has been established. However, it is possible to determine whether or not the cellular phone 1 is at a specific location based on current positional information received by the GPS unit 24.

In addition, each of the embodiments is not limited to a cellular phone, and is likewise adapted to other portable terminal devices, such as a PDA (Personal Data Assistant), electronic camera, electronic wristwatch, and music player.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2007-104381 filed on Apr. 12, 2007 and including specification, claims, drawings and summary. The disclosure of the above Japanese Patent Application is incorporated herein by reference in its entirety.

What is claimed is:

1. A portable terminal device that accesses and outputs user use information usable by a user, comprising:
an environment information storage unit that stores and manages a use environment fit for using each piece of the user use information in association therewith;
an acquisition unit that acquires a current environment; and
an output control unit that accesses and outputs user use information associated by the environment information storage unit with the current environment acquired by the acquisition unit at a time of accessing the user use information.

2. The portable terminal device according to claim 1, wherein the environment information storage unit stores and manages, for each piece of user use information, access identification information for designating access to the user use information and use environment conditions fit for using the user use information in association with each other, and
when a result of comparing the current environment acquired by the acquisition unit with the use environment conditions stored and managed by the environment information storage unit shows that the current environment corresponds to one of the use environment conditions, the output control unit accesses and outputs user use information based on the access identification information associated with the corresponding use environment condition.

3. The portable terminal device according to claim 2, wherein the user use information is stored and managed by a server unit connected to the portable terminal device over a communication network, and
the access identification information designates user use information to be downloaded from the server unit.

4. The portable terminal device according to claim 2, wherein the user use information is stored in a memory of the portable terminal device, and
the access identification information designates user use information to be read out from the memory.

5. The portable terminal device according to claim 1, wherein the user use information is telephone directory information including telephone numbers for respective communication counter parties, and
the environment information storage unit stores and manages the use environment in association with each of plural types of telephone directories provided for different usages.

6. The portable terminal device according to claim 1, further comprising a usage selection unit that selects a usage, wherein
the environment information storage unit stores and manages a usage in addition to the use environment in association with each piece of user use information, and
when the use environment corresponds to the current environment and the usage corresponds to the one selected by the usage selection unit, the output control unit accesses and outputs user use information associated with the environment and the usage.

7. The portable terminal device according to claim 1, further comprising:
a selection unit that selects one of plural pieces of local identification information which are separately used according to a usage at a time of executing a communication process with the local identification information being stored and managed; and
a control unit that stores communication history information of the communication process as the user use information in association with the local identification information selected by the selection unit when the communication process is executed based on the selected local identification information.

8. The portable terminal device according to claim 1, further comprising a control unit that stores, when the user use information is processed, the current environment acquired by the acquisition unit as the use environment corresponding to the user use information,
wherein at a time of referring to the user use information, the output control unit compares the current environment acquired by the acquisition unit with the use environment corresponding to the user use information, and extracts and outputs that user use information which corresponds to the current environment.

9. The portable terminal device according to claim 8, wherein the user use information is communication history information newly generated for each communication process, and
every time the communication history information is generated, the control unit stores the current environment acquired by the acquisition unit as the use environment corresponding to the communication history information.

10. The portable terminal device according to claim 9, wherein with a use environment condition being stored and managed as a condition to limit reference to the communication history information, the control unit determines whether the current environment acquired by the acquisition unit corresponds to the use environment condition every time new communication history information is generated, and stores the current environment as the use environment corresponding to the communication history information when the current environment corresponds to one of the use environment conditions.

11. The portable terminal device according to claim 8, wherein the user use information is file information newly acquired for each file process, and
at a time of executing a process on the file information, the control unit stores the current environment acquired by the acquisition unit as the use environment corresponding to the file information.

12. The portable terminal device according to claim 11, wherein with a use environment condition being stored and managed as a condition to limit reference to the file information, the control unit determines whether the current environment acquired by the acquisition unit corresponds to the use environment condition every time file information is processed, and stores the current environment as the use environment corresponding to the file information when the current environment corresponds to one of the use environment conditions.

13. The portable terminal device according to claim 1, wherein
when it is possible to communicate with one of a plurality of external devices having a predetermined communication range, the acquisition unit acquires presence of the portable terminal device in the communication range where communication with that external device is enabled as a current environment,
the environment information storage unit stores and manages information on an external device having a communication range fit for using the user use information in association with each piece of user use information, and
the output control unit accesses and outputs user use information associated with that external device which is in the current environment acquired by the acquisition unit.

14. The portable terminal device according to claim 13, wherein
when it is not possible to communicate with any one of the plurality of external devices, the acquisition unit acquires presence of the portable terminal device out of a communicatable range as a current environment, and
the output control unit accesses and outputs every user use information stored and managed by the environment information storage unit.

15. The portable terminal device according to claim 14, wherein
the plurality of external devices are a plurality of access points included in a wireless LAN, and
together with the wireless LAN, the access points perform relay between an external communication network and the portable terminal device.

16. A storage medium storing a program that allows a computer to achieve:
an environment information storage function of storing and managing a use environment fit for using each piece of the user use information in association therewith;
an acquisition function of acquiring a current environment; and
an output control function of accessing and outputting the user use information associated with the current environment acquired by the acquisition function.
